(19) United States
(12) Patent Application Publication
(10) Pub. No.: US 2009/0144834 A1
(43) Pub. Date: Jun. 4, 2009

(54) DATA PROCESSING CIRCUIT AND COMMUNICATION MOBILE TERMINAL DEVICE

(76) Inventors: Yoshinori MOCHIZUKI, Tokyo (JP); Masaharu Ukeda, Tokyo (JP); Shigemasa Shiota, Tokyo (JP); Takeo Kon, Tokyo (JP)

Correspondence Address: MATTINGLY & MALUR, P.C., 1800 DIAGONAL ROAD, SUITE 370, ALEXANDRIA, VA, 22314, US

(21) Appl. No.: 12/271,099

(22) Filed: Nov. 14, 2008

(30) Foreign Application Priority Data
Nov. 16, 2007 (JP) JP 2007-298092

(51) Int. Cl. H04L 9/32; H04M 1/00; G06F 12/02

(52) U.S. Cl. 726/27; 455/550.1; 711/102; 711/E12.007

(57) ABSTRACT

A data processing circuit includes a rewritable nonvolatile memory and a controller performing nonvolatile memory control and external interface control. A first detector and a second detector are employed to detect respectively whether the operation of the data processing circuit deviates from a first operating condition and a second operating condition, wherein the second operating condition is severer than the first operating condition. When the first detector detects deviation from the first operating condition, reset is instructed to the controller. When the second detector detects deviation from the second operating condition, the controller backs up an internal state and imposes a restriction on external access to a storage region of the nonvolatile memory. Accordingly, when operation of the microcontroller deviates from specific operating conditions within an operation guarantee range and performance degradation is exhibited, an unauthorized access to the data inside the microcontroller can be suppressed.

### CLAIM OF PRIORITY

The present application claims priority from Japanese application JP 2007-298092 filed on Nov. 16, 2007, the content of which is hereby incorporated by reference into this application.

### FIELD OF THE INVENTION

The present invention relates to a data processing circuit provided with a microcontroller, for example, an IC card or a subscriber identity module card, and further relates to technology which is effective when applied to a communication mobile terminal device mounting a subscriber identity module card.

### BACKGROUND OF THE INVENTION

A data processing circuit represented by an IC card is provided with tamper resistance as protection power against an internal analysis (reverse engineering) or alteration. For example, as the tamper resistance in order to protect important data stored in a memory in a microcontroller from an external attack such as a current analysis or a physical analysis, a microcontroller applied to an IC card (a microcontroller for IC cards) is provided with a detection circuit which detects a temperature value, a voltage value, an operating frequency value, etc. in a range which deviates from the use conditions or operating conditions specified as specification of the microcontroller. When a temperature value, a voltage value, or an operating frequency value outside a specified range is detected, the detection circuit sends a reset signal to the microcontroller, and shifts the microcontroller to the state at the time of activation. Owing to the detection circuit, important data can be protected from an external attack.

Document 1 (Japanese patent laid-open No. 2001-101088) discloses the following technology. When a voltage drop detection circuit detects a voltage value lower than a first detection voltage, for example, 9V, the voltage drop detection circuit outputs an interrupt signal of the highest priority (3a) such as NMI to CPU, according to this, CPU backs up data to a nonvolatile memory; and when the voltage drop detection circuit detects a voltage value lower than a second detection voltage, for example, 7V, the voltage drop detection circuit resets CPU via a reset circuit. In the description of Document 1, after completing the backup process, CPU is reset by stopping a pulse to a watchdog timer. According to this technology, it becomes possible to confirm the state of a microcontroller at the time when the detection circuit has detected abnormalities, after the resetting is performed.

Document 2 (Japanese patent laid-open No. Hei6 (1994)-35562) discloses technology in which when a power supply voltage becomes less than 4.75V, interruption is requested to CPU and the measure of abnormality such as evacuating data to a memory is performed, and when the power supply voltage becomes less than 4.5V, CPU is reset. According to this technology, it becomes possible to confirm the state of a microcontroller at the time when the abnormalities of the power supply voltage have been detected, after the resetting is performed.

In Document 3 (Japanese patent laid-open No. Hei8 (1996)-179993) discloses technology in which a circuit which detects property degradation of a flash memory is provided and when the property degradation is detected, operation of CPU is stopped by interruption. According to this technology, advance of the property degradation of the flash memory can be suppressed.

### SUMMARY OF THE INVENTION

The present inventors have studied how to protect data in a microcontroller against an external attack. When a voltage value in a prescribed range which deviates from the use conditions or operating conditions specified as specifications of a microcontroller is detected, an internal state can be backed up before resetting the microcontroller. From the viewpoint of efficiency of data processing, it is not advisable to reset the microcontroller immediately after the backup. The reason is that a power supply voltage, an operating frequency, etc. may change in real operation which is unrelated to an unauthorized access. However, the measure to an unauthorized access is necessary and only mere backup is insufficient for the measure. For example, a memory provided in a microcontroller, such as EEPROM or a flash memory, exhibits deteriorated performance as a device, as the number of times of writing or rewriting increases. Therefore, even when the data stored at the flash memory etc. is read with an operation power voltage within the range specified by the specifications of the microcontroller, it is likely that a different value from the expected value may be read. It is likely that an unauthorized access to the data may be performed, by making such a state positively and inducing malfunction. As described above, if reset is performed immediately after the backup, the reset will be performed whenever a power supply voltage, an operating frequency, etc. changes in real operation which is unrelated to an unauthorized access. Therefore, it is likely that the data processing efficiency may fall remarkably. Document 1 and Document 2 failed in taking into consideration these points. The technology disclosed by Document 3 aims to impede advance itself of the property degradation of a memory, and there is no viewpoint which connects the property degradation of a memory to the suppression of an unauthorized access.

The present invention has been made in view of the above circumstances and provides a data processing circuit which can confirm an internal state afterwards, when operation of a microcontroller deviates from specific operating conditions within an operation guarantee range and exhibits performance degradation, and which can contribute to the suppression of an unauthorized access to data inside the microcontroller in such a state.

The above and other purposes and new features of the present invention will become clear from the description of the present specification and the accompanying drawings.

The following simply explains an outline of a typical embodiment of the invention disclosed by the present application.

That is, a data processing circuit includes a rewritable nonvolatile memory and a controller which performs control of the nonvolatile memory and external interface control. A first detector which detects whether or not the operation of the data processing circuit deviates from a first operating condition and a second detector which detects whether or not the operation of the data processing circuit deviates from a second operating condition which is severer than the first operating condition are employed. When the first detector detects deviation from the first operating condition, reset is instructed to the controller in response to the detection. Furthermore, when the second detector detects deviation from the second operating condition, the controller makes a backup of an internal state and imposes a restriction on external access to a storage region of the nonvolatile memory. When the operation of the controller deviates from the second operating condition and exhibits performance degradation, it is possible to confirm the internal state afterwards by the backup. By performing an access restriction, it is possible to contribute to suppression of unauthorized access by which the data inside the controller may be altered or referred to, disregarding access authority, in such a state of the performance degradation.

The following explains briefly the effect acquired by the typical embodiment of the invention disclosed by the present application.

That is, when the operation of the microcontroller in the data processing circuit deviates from specific operating conditions within an operation guarantee range and exhibits performance degradation, it is possible to confirm afterwards the internal state and it is also possible to contribute to suppression of the unauthorized access to data inside the microcontroller in such a state.

### BRIEF DESCRIPTION OF THE DRAWINGS

These and other features, objects and advantages of the present invention will become more apparent from the following description when taken in conjunction with the accompanying drawings, wherein:

FIG. 1 is a block diagram illustrating an example of a data processing circuit according to an embodiment of the present invention;

FIG. 2 is a flow chart illustrating an entire control operation by a microcontroller when a voltage detection circuit and frequency detectors detect abnormal values;

FIG. 3 is a flow chart illustrating operation of a microcontroller which has shifted to a protect mode;

FIG. 4 is a block diagram illustrating an example of a macro controller provided with a counter and mounted in a data processing circuit;

FIG. 5 is a block diagram illustrating an example of EEPROM mounted in a data processing circuit in lieu of the counter of FIG. 4, and having a performance monitoring area;

FIG. 6 is a block diagram illustrating a data processing circuit provided with a temperature detection control circuit in lieu of the frequency detection control circuit;

FIG. 7 is a flow chart illustrating an entire control operation by a microcontroller when a frequency detection circuit and a temperature detector detect an unusual value;

FIG. 8 is a block diagram illustrating a data processing circuit provided with a voltage detection control circuit in lieu of the temperature detection control circuit;

FIG. 9 is a flow chart illustrating an entire control operation by a microcontroller when a frequency detection circuit and a voltage detector detect an unusual value; and

FIG. 10 is a block diagram illustrating a communication mobile terminal device to which a data processing circuit is applied.

### DETAILED DESCRIPTION OF THE PREFERRED EMBODIMENTS

### 1. Outline of Typical Embodiment

First, an outline is explained on a typical embodiment of the invention disclosed in the present application. A numerical symbol in parentheses referring to a component of the drawing in the outline explanation about the typical embodiment only illustrates what is included in the concept of the component to which the numeral symbol is attached.

(1) A data processing circuit comprises: a rewritable nonvolatile memory; a controller (147, 147A) which performs access control of the nonvolatile memory and external interface control; a first detector (152, 192, 202); a second detector (154, 194, 204), and a reset circuit (130). The first detector detects whether or not the operation of the data processing circuit deviates from a first operating condition. The second detector detects whether or not the operation of the data processing circuit deviates from a second operating condition which is severer than the first operating condition. The reset circuit instructs the controller to perform reset, in response to the state that the first detector detects deviation from the first operating condition. When the second detector detects deviation from the second operating condition, the controller makes a backup of an internal state and imposes a restriction on external access to a storage region of the nonvolatile memory.

When the operation of the data processing circuit deviates from the second operating condition and the performance of the controller and the nonvolatile memory deteriorates, it is possible to confirm the internal state afterwards by using the backup. By performing an access restriction, it is possible to contribute to suppression of unauthorized access by which the data inside the nonvolatile memory is altered or referred to, disregarding access authority, in such a state of the performance degradation.

(2) In the data processing circuit of the item (1), the controller includes an input-output control circuit (142) which controls input-output with the exterior, and the controller imposes an external input/output restriction on the input-output control circuit when the second detector detects deviation from the second operating condition. By imposing the external input/output restriction, it is possible to contribute to suppression of unauthorized access, similarly to the above.

(3) In the data processing circuit of the item (1), the controller includes a counter (160) which integrates and holds a period of the operation, and the integrated value by the counter exceeding a predetermined value is used as one of conditions for imposing the access restriction. If the access restriction is imposed from the beginning, the data processing efficiency will be reduced by the access restriction imposed in spite of the fact that the property of the nonvolatile memory has not deteriorated. On the contrary, if the access restriction is imposed after the degradation of a property advances to some extent, coping action can be taken, after unexpectedly-changed data of the nonvolatile memory has become obvious and likeliness of an attack of an unauthorized access has become realistic, and reduction of the data processing efficiency can be controlled to the minimum.

(4) In the data processing circuit of the item (2), the controller includes a counter which integrates and holds a period of the operation, and the integrated value by the counter exceeding a predetermined value is used as one of conditions for imposing the external input/output restriction. If the external input/output restriction is imposed from the beginning, the data processing efficiency will be reduced by the external input/output restriction imposed in spite of the fact that the property of the nonvolatile memory has not deteriorated. On the contrary, if the external input/output restriction is imposed after degradation of a property advances to some extent, coping action can be taken, after unexpectedly-changed data of the nonvolatile memory has become obvious and likeliness of an attack of an unauthorized access has become realistic, and reduction in the data processing efficiency can be controlled to the minimum.

(5) In the data processing circuit of the item (1), the nonvolatile memory has a monitoring area (171) which stores specific data in a part of a storage area in write-in units (170), and is enabled to be electrically written in the write-in units. When the controller detects that data read from the monitoring area in accessing the nonvolatile memory is altered to data other than the specific data, the detection by the controller is used as one of conditions for imposing the access restriction. If the access restriction is imposed after the state of the property degradation of the monitoring area is actually grasped, coping action can be taken, after unexpectedly-changed data of the nonvolatile memory has become obvious and likeliness of an attack of an unauthorized access has become realistic, and reduction in the data processing efficiency can be controlled to the minimum.

(6) In the data processing circuit of the item (2), the nonvolatile memory has a monitoring area which stores specific data in a part of a storage area in write-in units, and is enabled to be electrically written in the write-in units. When the controller detects that data read from the monitoring area in accessing the nonvolatile memory is altered to data other than the specific data, the detection by the controller is used as one of conditions for imposing the external input/output restriction. If the external input/output restriction is imposed after the state of the property degradation of the monitoring area is actually grasped, coping action can be taken, after unexpectedly-changed data of the nonvolatile memory has become obvious and likeliness of an attack of an unauthorized access has become realistic, and reduction in the data processing efficiency can be controlled to the minimum.

(7) In the data processing circuit of the item (1), the first operating condition is one of the operation guarantee conditions in operation specifications of the data processing circuit.

(8) In the data processing circuit of the item (1), the first detector and the second detector input a clock signal supplied from an external clock contact (116). The first operating condition is that a frequency of the clock signal is within the range of a first frequency band, and the second operating condition is that the frequency of the clock signal is within the range of a second frequency band which is set in the first frequency band. It is possible to directly cope with an act to try to perform unauthorized access by degrading the clock signal frequency and inducing malfunction intentionally.

(9) In the data processing circuit of the item (1), the first detector and a second detector input a power supply voltage supplied from an external power contact (110,112). The first operating condition is that the power supply voltage is within a first voltage range and the second operating condition is that the power supply voltage is within a second voltage range which is set in the first voltage range. It is possible to directly cope with an act to try to perform unauthorized access by degrading the power supply voltage and inducing malfunction intentionally.

(10) In the data processing circuit of the item (1), the first detector and the second detector detect temperature of the data processing circuit. The first operating condition is that the detected temperature is within a first temperature range, and a second operating condition is that the detected temperature is within a second temperature range which is set in the first temperature range. It is possible to directly cope with an act to try to perform unauthorized access by degrading the temperature environment of the data processing circuit and inducing malfunction intentionally.

(11) In the data processing circuit of the item (1), the data processing circuit includes the controller and the nonvolatile memory as a microcontroller for IC cards (140) and further includes an external contact in conformity with the ISO 7816-2 standard. The tamper resistance of the microcontroller for IC cards can be improved.

(12) The data processing circuit of the item (11) is a subscriber identity module card. The tamper resistance of the subscriber identity module card can be improved.

(13) A communication terminal device comprises a data processing circuit as described in the item (12) as a subscriber identity module card. It is possible to contribute to safety enhancements in dealings etc., using the communication terminal device.

### 2. Details of Embodiment

The embodiment is explained further in full detail. Hereafter, the best mode for carrying out the present invention is explained in detail based on the accompanying drawings. In all the drawings for explaining the best mode for the invention, the same sign is attached to a member which has the same function, and the repetitive explanation thereof is omitted.

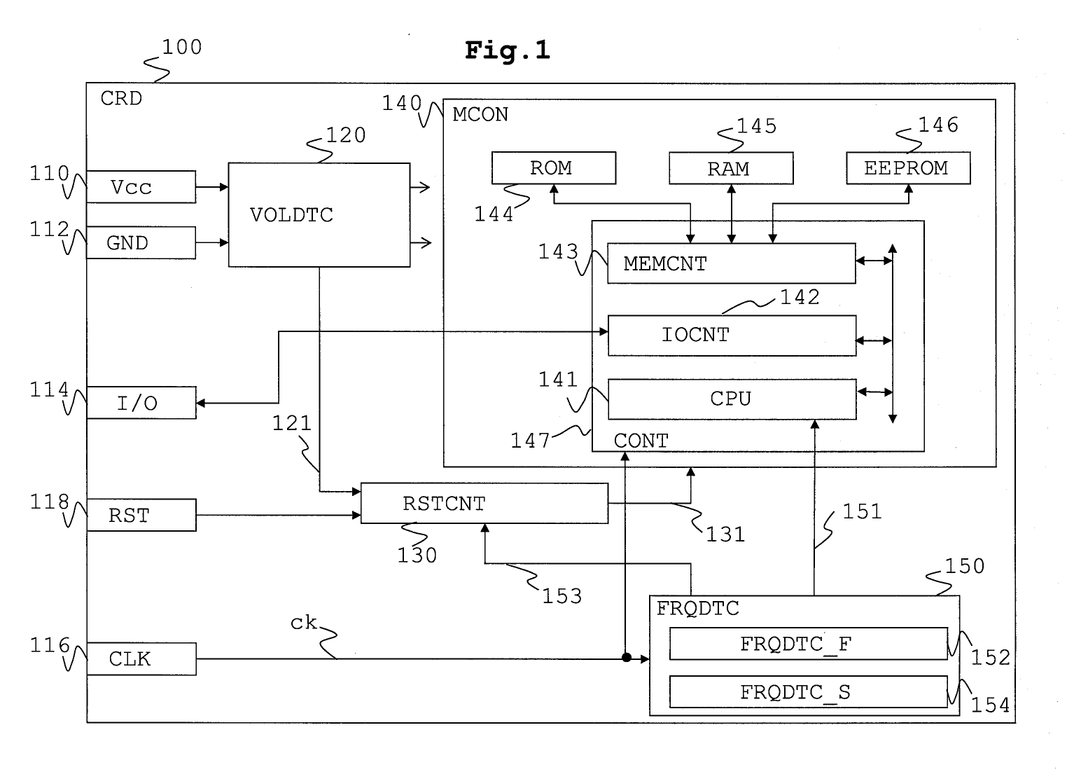

FIG. 1 illustrates an example of a data processing circuit according to an embodiment of the present invention. Although not restricted in particular, the data processing circuit illustrated in FIG. 1 is assumed to serve as an IC card, a subscriber identity module card, or a memory card with a security function.

The data processing circuit (CRD) 100 has, as external interface contacts in conformity with the ISO 7816-2 standard, for example, a power supply contact (Vcc) 110, a ground contact (GND) 112, an input-output contact (I/O) 114, a clock input contact (CLK) 116, and a reset contact (RST) 118, in a card substrate. The data processing circuit 100 includes a voltage detection circuit (VOLDTC) 120, a reset control circuit (RSTCNT) 130, a frequency detection circuit (FRQDTC) 150, and a microcontroller (MCON) 140 which are mounted in the card substrate. These elements are formed by a single chip or multi chips.

Although not restricted in particular, the microcontroller 140 includes an electrically-rewritable nonvolatile memory (EEPROM) 146, a volatile memory (RAM) 145, a read-only nonvolatile memory (ROM) 144, and a controller 147 which performs memory control and external interface control. The controller 147 has a central processing unit (CPU) 141 which fetches and executes an instruction, an input-output control circuit (IOCNT) 142 which performs input/output control with the exterior, and a memory control circuit (MEMCNT) 143 which controls internal memories 144,145,146, for example. CPU 141 uses RAM 145 for a work region or a temporary storage region of data when CPU 141 fetches and executes a program stored in ROM 144. In the program execution by CPU 141, upon detecting a request of memory access, the memory control circuit 143 performs an access control in the procedure appropriate to an accessing target memory based on the access address.

Vcc 110 is an interface for supplying an operation power supply of the data processing circuit 100, and a contact C1 is assigned in ISO 7816-2. GND 112 is a contact which supplies a ground potential to the data processing circuit 100, and a contact C5 is assigned in ISO 7816-2. I/O 114 is an interface for the data processing circuit 100 to transmit and receive APDU (Application Protocol Data Unit), i.e., data of a command, a response, etc. to and from the exterior, and a contact C7 is assigned in ISO 7816-2. I/O 114 is coupled to the input-output control circuit 142. CLK 116 is an interface for inputting a clock signal necessary in order that the data processing circuit 100 may perform the processing in conformity with ISO 7816-3, and a contact C3 is assigned in ISO 7816-2. A clock signal ck supplied from CLK 116 is used as an operation reference clock of the microcontroller 140. The frequency of the clock signal ck affects the instruction execution cycle time of CPU 141, the access cycle time to the memories 144-146, and the writing operation time and erasing operation time of EEPROM 146. RST 118 is an interface through which a reset signal is supplied to the data processing circuit 100 from the exterior, and a contact C2 is assigned in ISO 7816-2. A reset signal 131 is supplied to the microcontroller 140. When reset is instructed to the microcontroller 140, the logical value of a storage circuit (register) and a data path inside the controller is initialized, and the memory content of RAM 145 is also initialized. The reset signal supplied via RST 118 is called an external reset in the following. In communication in conformity with ISO 7816-3, even if which contact is assigned to which interface, as far as the assignment is clearly defined, the essence of the following explanation will not be influenced.

The data processing circuit 100 mounts a detection circuit such as the voltage detection circuit 120 and the frequency detection control circuit 150, in order to protect the data stored in the data processing circuit 100 from an external attack such as a current analysis or a physical analysis

The voltage detection circuit 120 detects whether the power supply voltage supplied from Vcc 110 deviates from a voltage range of the operation guarantee range of the operation specifications which is specified by a user's manual, etc. of the data processing circuit 100. When the voltage detection circuit 120 detects that the power supply voltage deviates from the voltage range of the operation guarantee range, the voltage detection circuit 120 makes a request for reset to the reset control circuit 130 by a reset request signal 121. When reset is requested, the reset control circuit 130 activates a reset signal 131, and instructs the reset to the microcontroller 140.

Two kinds of frequency detectors, a first frequency detector (FRQDTC_F) 152 and a second frequency detector (FRQDTC_S) 154, are mounted in the frequency detection control circuit 150. The first frequency detector 152 detects whether or not the frequency of the clock signal ck supplied from the clock input contact 116 deviates from the first frequency band. The first frequency band is one of the operation guarantee conditions of the operation specifications specified by the user's manual, etc. of the data processing circuit 100, and implies the range from a lower limit frequency to an upper limit frequency of the clock signal ck, which is necessary in order to obtain desired performance. The second frequency detector 154 detects whether or not the frequency of the clock signal ck supplied from the clock input contact 116 deviates from the second frequency band which is set in the first frequency band. The second frequency band implies severer operating conditions than the operation guarantee conditions specified by the first frequency band. Specifically, the second frequency detector 154 is a circuit for detecting a frequency value outside the range in which the data can be read as expected from EEPROM 146 of which the performance has deteriorated. When the range of the abnormal frequency value which the first frequency detector 152 detects and the range of the abnormal frequency value which the second frequency detector 154 detects are compared, it is common that the second frequency detector 154 can detect an abnormal state in a broader frequency range.

For example, the voltage detection circuit 120 detects a voltage value outside a range from −1.0V to 10.0V, the first frequency detector 152 detects a frequency value outside a range from 300 kHz to 10.0 MHz, and the second frequency detector 154 detects a frequency value outside a range from 1 MHz to 6 MHz.

When the first frequency detector 152 detects that the frequency of the clock signal ck deviates from the first frequency band, the frequency detection control circuit 150 issues a reset request 153 to the reset control circuit 130, and the reset control circuit 130, upon receiving the reset request 153, initializes the microcontroller 140 with the reset signal 131. When the second frequency detector 154 detects that the frequency of the clock signal ck deviates from the second frequency band, the frequency detection control circuit 150 instructs the shift to a protect mode for example, by an abnormal frequency detection signal 151. The details of the protect mode are explained later.

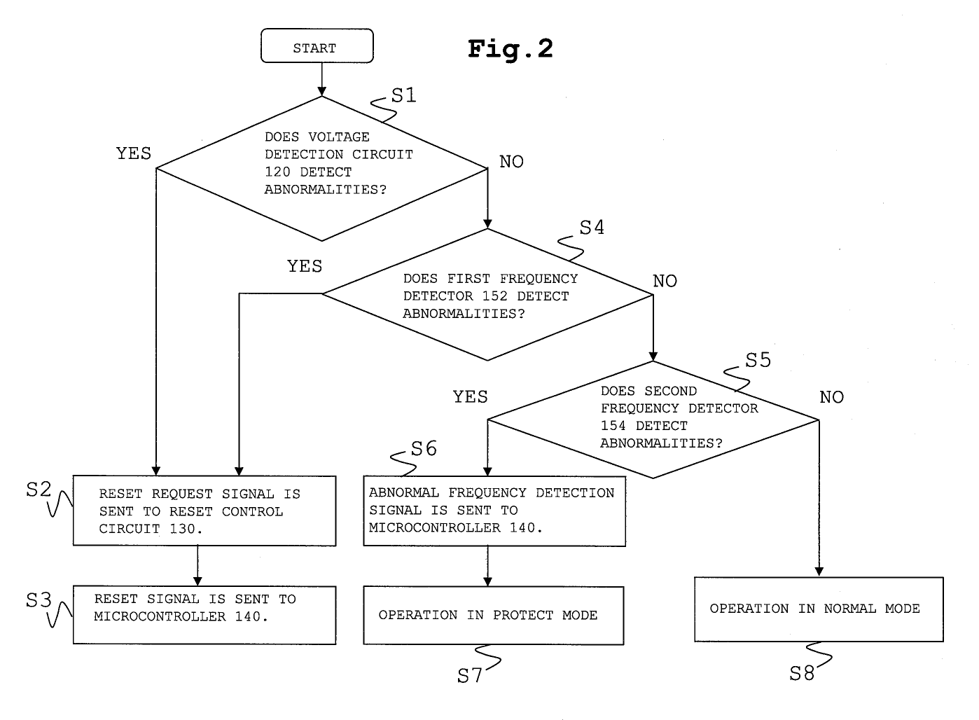

FIG. 2 illustrates an entire control operation by the microcontroller 140 when the voltage detection circuit 120 and the first frequency detector 152 and the second frequency detector 154 detect an abnormal value. The abnormal value here means a value outside the range specified by the user's manual, or a value in the range in which CPU 141 cannot read data as expected to the data stored in EEPROM 146 of which the performance deteriorates, as mentioned above.

When the voltage detection circuit 120 detects an abnormal voltage value, the voltage detection circuit 120 sends a reset request signal to the reset control circuit 130 (Steps S1, S2). The reset control circuit 130, upon receiving the reset request signal, sends the reset signal 131 to the microcontroller 140 (Step S3). Upon receiving the reset signal, the microcontroller 140 shifts to the state at the time of activation, i.e., to the initial state, even when the microcontroller is performing any kind of operation.

When the voltage detection circuit 120 does not detect an abnormal voltage value but the first frequency detector 152 detects an abnormal frequency value, the first frequency detector 152 sends a reset request signal to the reset control circuit 130, as in the case where the voltage detection circuit 120 detects an abnormal voltage value (Steps S4, S2). The subsequent processing is the same as that of the case where the voltage detection circuit 120 detects an abnormal voltage value (Step S3).

When the voltage detection circuit 120 and the first frequency detector 152 do not detect an abnormal value but the second frequency detector 154 detects an abnormal frequency value, the abnormal frequency detection signal 151 is sent to the microcontroller 140 (Steps S5, S6). Upon receiving the abnormal frequency detection signal 151, the microcontroller 140 shifts to the protect mode (Step S7).

When the voltage detection circuits 120, the first frequency detectors 152, and the second frequency detectors 154 all do not detect an abnormal value, the microcontroller 140 operates in the normal mode without a special limitation in access to the memory of EEPROM 146, etc. (Step S8).

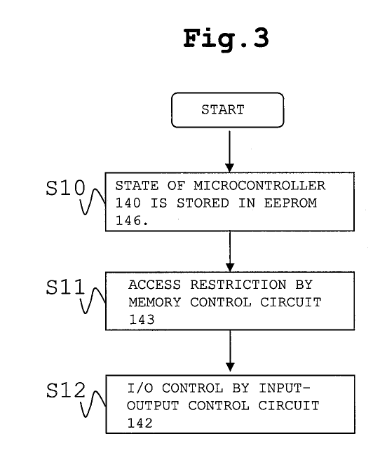

FIG. 3 illustrates operation of the microcontroller 140 which has shifted to the protect mode. Upon receiving the abnormal frequency detection signal 151 from the second frequency detector 154, CPU 141 performs the backup operation which stores data in a stack, internal values of a general-purpose register, etc. to EEPROM 146 (Step S10). The backup operation may be automatically repeated for every prescribed period, once receiving the abnormal frequency detection signal 151. The repeating interval may be determined by using a timer etc. (not shown). If the data processing circuit 100 is under unauthorized attack, the attacker carries out the attack first at a frequency value which the second frequency detector 154 detects abnormalities and next at a frequency value which the first frequency detector 152 detects abnormalities. The backup operation is prepared for the attack in which the data processing circuit is operated at a frequency at which the first frequency detector 152 detects abnormalities, for example. By performing this operation, even when the second frequency detector 154 and the voltage detection circuit 120 detect an abnormal value afterward, the state of the microcontroller just before detecting the abnormal value can be confirmed after reset by using the data stored EEPROM 146. It is also possible to restore the state of the microcontroller 140 to the state just before detecting the abnormal value from the initial state, by the intermediary of the initializing operation program of CPU 146. This is useful to prevent an attempt which generates abnormalities compulsorily in the middle of processing of the accounting information or the balance data and nullifies the latest data.

Based on the abnormality detection value by the second frequency detector 154, CPU 141 instructs the memory control circuit 143 to impose access restriction to the storage region of EEPROM 146 from the outside, in addition to the backup operation (Step S11). The access restriction by the memory control circuit 143 prohibits accessing to all the data stored in EEPROM 146. In the case where the address of the area storing important data is decided beforehand, the memory control circuit 143 may perform control to prohibit CPU 141 from accessing only the data which is stored in the address storing the important data. By performing such memory control, important data such as information with respect to money or information with respect to users can be protected from the external attack.

Based on the abnormality detection value by the second frequency detector 154, CPU 141 instructs the input-output control circuit 142 to impose an external input/output restriction (Step S12). The external input/output restriction by the input-output control circuit 142 is a function which eliminates the access request from the outside to access EEPROM as a target, and no operation to send the access request concerned to the memory control circuit 143 is performed. Accordingly, the access request to EEPROM 146 can be eliminated in the preceding stage of the memory control circuit 143. When APDU which accesses the data stored in EEPROM 146 from an external terminal device is supplied as an input-output restriction, the current situation in which the access to EEPROM 146 is prohibited may be notified to the external terminal device, as a response of APDU. Accordingly, the access request to EEPROM 146 may be denied. To APDU other than the access request to the data stored in EEPROM 146, a response denying the request may be returned similarly.

By employing the protect mode as described above, even when the reset control circuit 130 has sent a reset signal, it is possible to shift the microcontroller 140 to the state before the reset signal has been sent, after receiving the reset signal, with the use of the initialization program. Furthermore, the data stored in a memory of which the performance deteriorates can be protected safely.

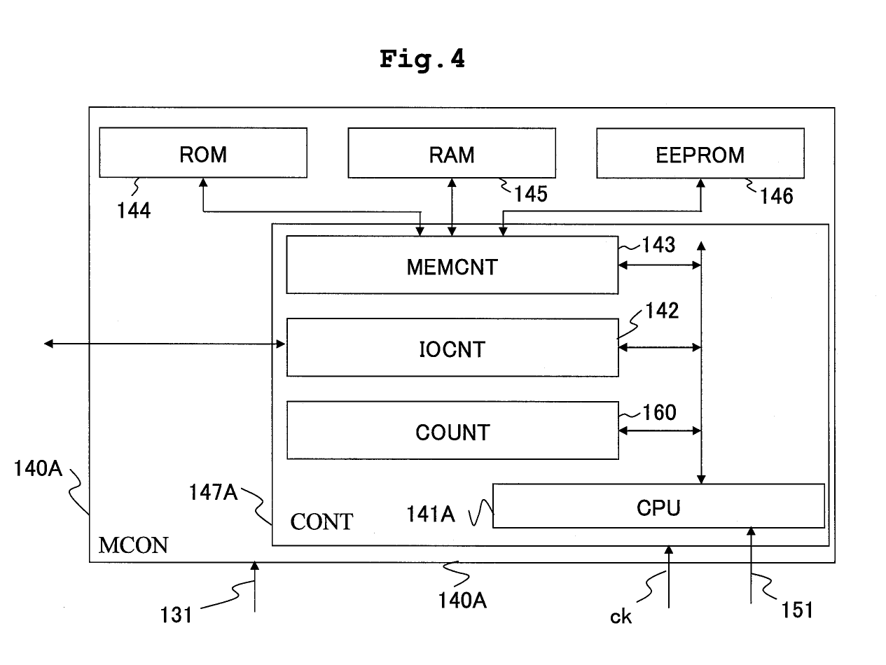

FIG. 4 illustrates another example of a macro controller mounted in the data processing circuit 100. A microcontroller 140A illustrated in FIG. 4 is different from the microcontroller 140 of FIG. 1 in that a controller 147A has a counter (COUNT) 160. The counter 160 aims at acquiring a usable value as an index of the property degradation of EEPROM 146 due to increase of the number of times of rewriting, and accumulates and holds the rewriting operation time or the number of times of rewriting of EEPROM. A second counter of a real-time clock, etc. may be used for the counter 160. The accumulation value by the counter 160 is successively stored in a nonvolatile storage register. When the abnormalities in frequency are detected by an abnormal frequency detection signal 151, CPU 141A determines whether the count value of the counter 160 exceeds a predetermined value. Only when the count value exceeds the predetermined value, the processing of access restriction and external input/output restriction in the protect mode is performed. The predetermined value is a value correlated with the accumulation time of rewriting operation, during which it is likely that unfavorable situation may occur, such that property degradations of EEPROM in write-in, erasure, and read-out may be caused by repeated rewriting operation, and that the written-in data in the data writing operation may be different from the target data, and that the read-out data may be changed unexpectedly.

According to the present constitution, the access restriction and the external input/output restriction are not imposed during the period in which it is determined that the performance of EEPROM 146 has not deteriorated. When the access restriction etc. is imposed from the beginning, data processing efficiency reduces due to the access restriction imposed, even if the property of the nonvolatile memory has not deteriorated. If the access restriction is imposed after degradation of a property advances to some extent, coping action can be taken after unexpectedly-changed data of the nonvolatile memory has become obvious and likeliness of an attack of an unauthorized access has become realistic, and reduction in the data processing efficiency can be controlled to the minimum.

Here, even if it is before the counter 160 reaches the predetermined value, the backup operation is performed. This is to give priority to the reliability in operation, since there is even a little possibility of causing an operation abnormality. When top priority is given to the data processing efficiency, the backup operation may not be performed before the counter 160 reaches the predetermined value.

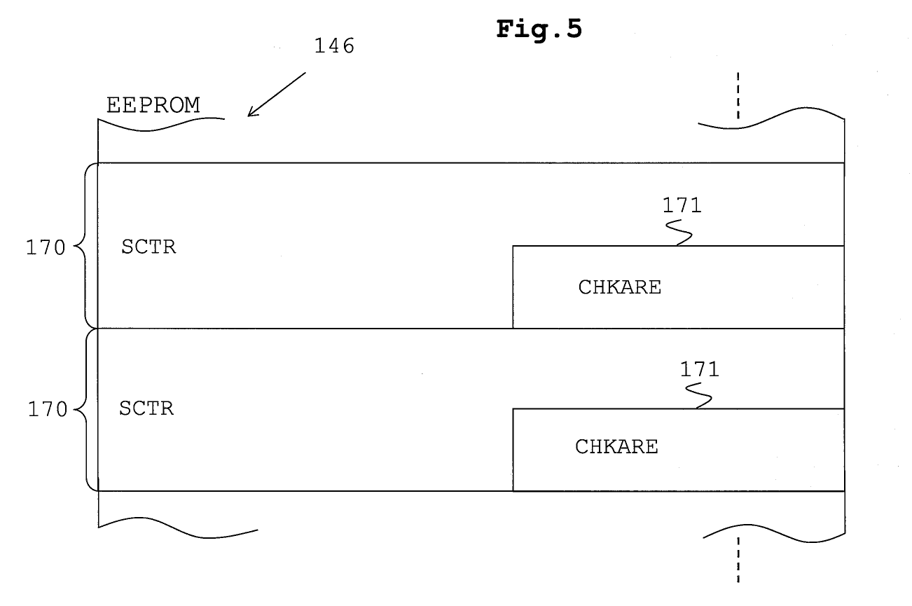

FIG. 5 illustrates an example of EEPROM mounted in the data processing circuit 100 in lieu of the counter of FIG. 4, and having a performance monitoring area. That is, apart of the storage region of EEPROM 146 in write-in units (SCTR) 170 such as a sector is made to serve as a performance monitoring area, and specific data (monitoring data) is written in the performance monitoring area (CHKARE) 171. The monitoring data may be written in the manufacturing stage of the microcontroller 140. While abnormalities are detected by the abnormality detection signal 151, CPU 141 reads the data in the performance monitoring area 171 of the accessing target sector 170 in access to EEPROM 146, and determines whether or not the read data is different from the monitoring data. When it is determined that the difference exists, the access restriction is imposed in addition to the backup operation. In writing operation, the data (monitoring data) stored in the performance monitoring area 171 of the write-in target sector 170 is rewritten each time. The write control may be performed by the memory control circuit 143 automatically. Unexpectedly-changed data will be produced to specific data by writing in excess of the number of times of the write-in guarantee. When the read data from the monitoring area is different from the proper monitoring data, it implies that the performance of EEPROM 146 has deteriorated. By the fact that data reading of EEPROM 146 by CPU 141 is prohibited by the access restriction in this state, malfunction, outflow of secrecy data, etc. are prevented. In the constitution of FIG. 5, since the access restriction is imposed after the degradation of property of EEPROM 146 advances to some extent as in FIG. 4, it is possible to devise a countermeasure after the unexpectedly-changed data of EEPROM 146 has become obvious and the possibility of suffering an unauthorized access has become realistic, and it is possible to control the reduction of the data processing efficiency to the minimum. When using in combination the constitution of FIG. 4 and the constitution of FIG. 5, the effect will improve further.

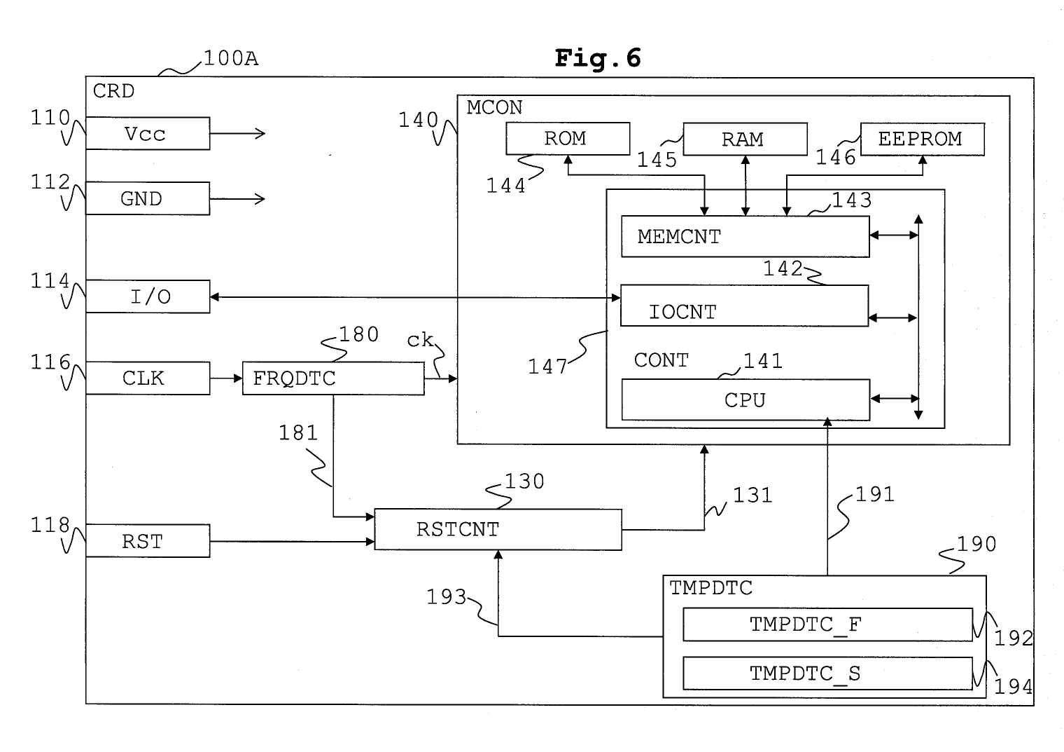

FIG. 6 illustrates a data processing circuit 100A provided with a temperature detection control circuit 190 instead of the frequency detection control circuit. The temperature detection control circuit (TMPDTC) 190 has a first temperature detector (TMPDTC_F) 192 and a second temperature detector (TMPDTC_S) 194. In the present example, a frequency detection circuit 180 is arranged in lieu of the voltage detection circuit 120.

The frequency detection circuit 180 is provided with the same detector function as the first frequency detector 152. When the frequency detection circuit 180 detects abnormal frequency, the frequency detection circuit 180 outputs a reset request 181 to the reset control circuit 130.

The temperature detector 192 detects whether or not the temperature of the data processing circuit 100A deviates from a first temperature range. The first temperature range is one of the operation guarantee conditions of the operation specifications specified with the user's manual, etc. of the data processing circuit 100A, and implies the range from a lower limit temperature to an upper limit temperature, which is necessary in order to obtain desired performance. The second temperature detector 194 detects whether or not the temperature of the data processing circuit 100A deviates from a second temperature range which is set in the first temperature range. The second temperature range implies severer operating conditions to the operation guarantee conditions specified by the first temperature range. Specifically, the second temperature detector 194 is a circuit for detecting a temperature value outside the range in which the data can be read as expected from EEPROM 146 of which the performance has deteriorated. When the normal temperature range which the first temperature detector 192 detects and the normal temperature range which the second temperature detector 194 detects are compared, the second temperature detector 194 will detect an abnormal state in a broader temperature range. For example, the first temperature detector 192 detects temperature outside a range from −25 degrees in Celsius to 85 degrees in Celsius, and the second temperature detector 194 detects temperature outside a range from −5 degrees to 60 degrees in Celsius.

When the first temperature detector 192 detects that the temperature of the data processing circuit 100A deviates from the first temperature range, the temperature detection control circuit 190 issues a reset request 193 to the reset control circuit 130, and then the reset control circuit 130 initializes the microcontroller 140 using the reset signal 131. When the second temperature detector 194 detects that the temperature of the data processing circuit 100A deviates from the second temperature range, the temperature detection control circuit 190 instructs the shift to a protect mode using an abnormal temperature detection signal 191. The protect mode is the same as the contents explained in FIG. 3.

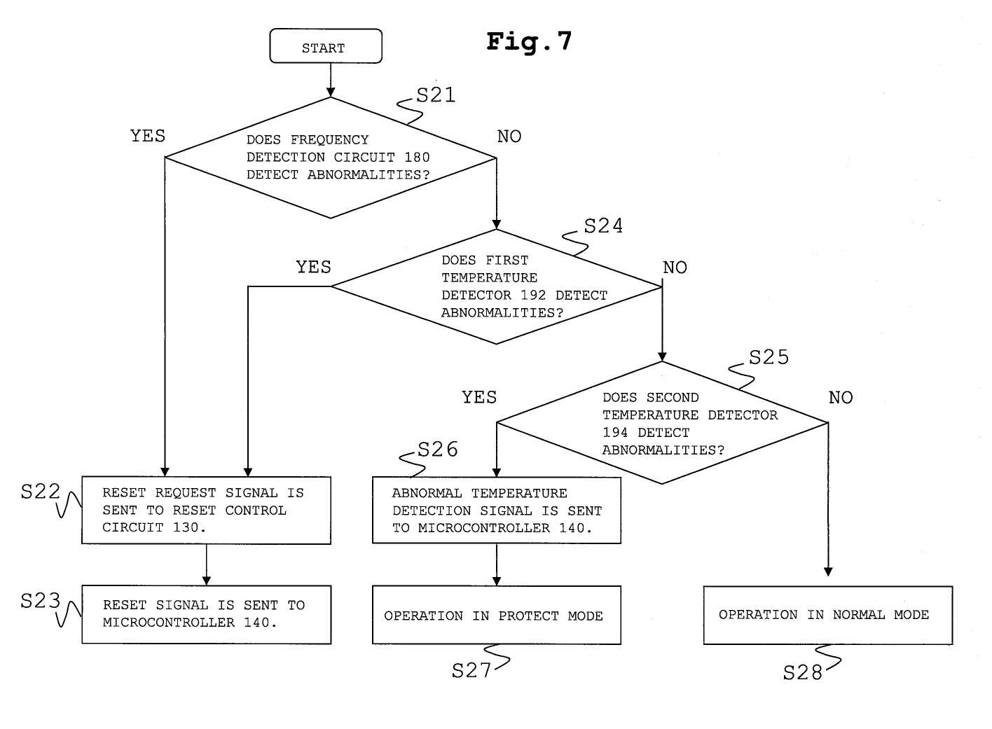

FIG. 7 illustrates an entire control operation by a microcontroller 140 when the first temperature detector 192 and the second temperature detector 194 detect an abnormal value. The abnormal value here means a value outside the range specified by the user's manual, or a value in the range in which CPU 141 cannot read data as expected to the data stored EEPROM 146 of which the performance deteriorates, as mentioned above.

When the frequency detection circuit 180 detects an abnormal frequency value, the frequency detection circuit 180 sends a reset request signal to the reset control circuit 130 (Steps S21, S22). The reset control circuit 130, upon receiving the reset request signal, sends the reset signal 131 to the microcontroller 140 (Step S23). The microcontroller 140, upon receiving the reset signal, moves to the initializing operation of the data processing circuit 10A.

When the frequency detection circuit 180 does not detect an abnormal frequency value but the first temperature detector 192 detects an abnormal temperature, the first temperature detector 192 sends a reset request signal to the reset control circuit 130, as in the case where the frequency detection circuit 180 detects an abnormal frequency value (Steps S24, S22). The subsequent processing is the same as that of the case where the frequency detection circuit 180 detects an abnormal frequency value (Step S23).

When the frequency detection circuit 180 and the first temperature detector 192 do not detect an abnormal value but the second temperature detector 194 detects an abnormal temperature, an abnormal temperature detection signal 191 is sent to the microcontroller 140 (Steps S25, S26). Upon receiving the abnormal temperature detection signal 191, the microcontroller 140 shifts to a protect mode (Step S27).

When all of the frequency detection circuit 180, the first temperature detector 192, and the second temperature detector 194 do not detect an abnormal value, the microcontroller 140 operates in the normal mode without a special limitation in access to the memory of EEPROM 146, etc. (Step S28).

According to the constitution of FIGS. 6 and 7, it is possible to directly cope with an act to try to perform unauthorized access by degrading the temperature environment of the data processing circuit and inducing malfunction intentionally.

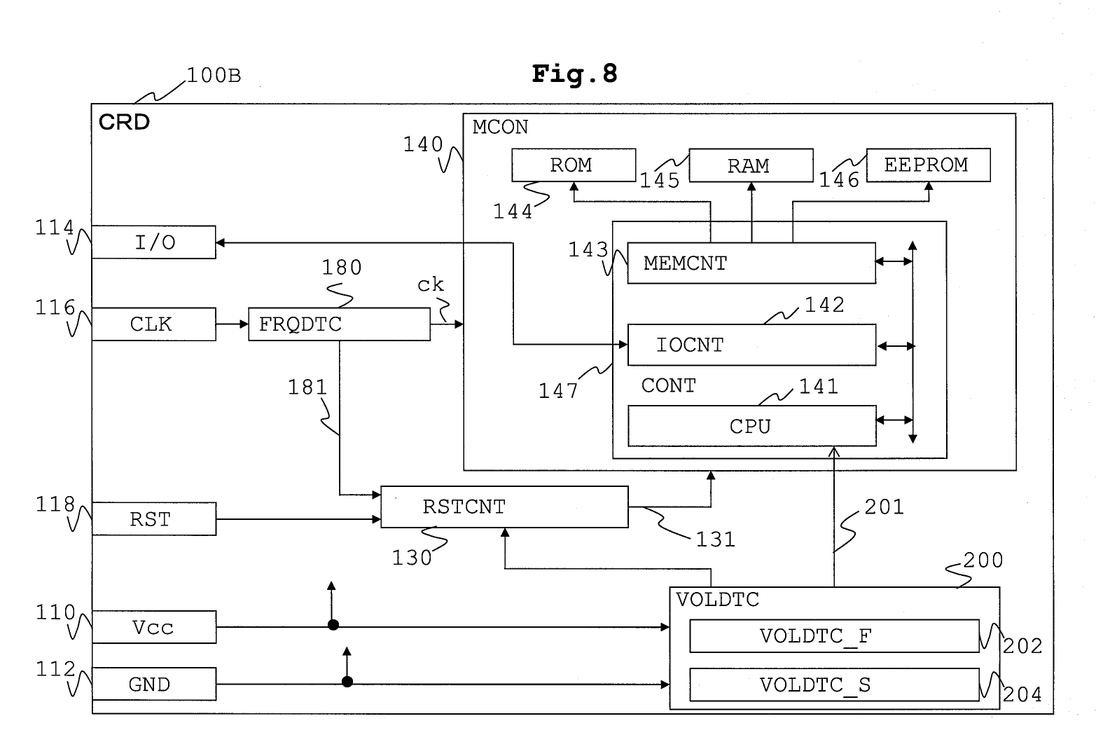

FIG. 8 illustrates a data processing circuit 100B provided with a voltage detection control circuit 200 instead of the temperature detection control circuit. The voltage detection control circuit (VOLDTC) 200 has a first voltage detector (VOLDTC_F) 202 and a second voltage detector (VOLDTC_S) 204. Other constitution is the same as that of FIG. 6.

The first voltage detector 202 detects whether or not the operation power supply of the data processing circuit 100B deviates from a first voltage range. The first voltage range is one of the operation guarantee conditions of the operation specifications specified with the user's manual, etc. of the data processing circuit 100B, and implies the range from a lower limit voltage to an upper limit voltage, which is necessary in order to obtain desired performance. The second voltage detector 204 detects whether or not the operation power supply of the data processing circuit 100B deviates from a second voltage range which is set in the first voltage range. The second voltage range implies severer operating conditions to the operation guarantee conditions specified by the first voltage range. Specifically, the second voltage detector 204 is a circuit for detecting an operating voltage outside the range in which data can be read as expected from EEPROM 146 of which the performance has deteriorated. When the normal voltage range which the first voltage detector 202 detects and the normal voltage range which the second voltage detector 204 detects are compared, the second voltage detector 204 will detect an abnormal state in a broader voltage range. For example, the first voltage detector 202 detects a power supply voltage outside a range from −1.0V to 10.0V, and the second voltage detector 204 detects a power supply voltage outside a range from 0V to 8.0V.

When the first voltage detector 202 detects that the operating voltage of the data processing circuit 100B deviates from the first voltage range, the voltage detection control circuit 200 issues a reset request 203 to the reset control circuit 130, and then the reset control circuit 130 initializes the microcontroller 140 using the reset signal 131. When the second voltage detector 204 detects that the operating voltage of the data processing circuit 100B deviates from the second voltage range, the voltage detection control circuit 200 instructs the shift to a protect mode using an abnormal voltage detection signal 201. The protect mode is the same as the contents explained in FIG. 3.

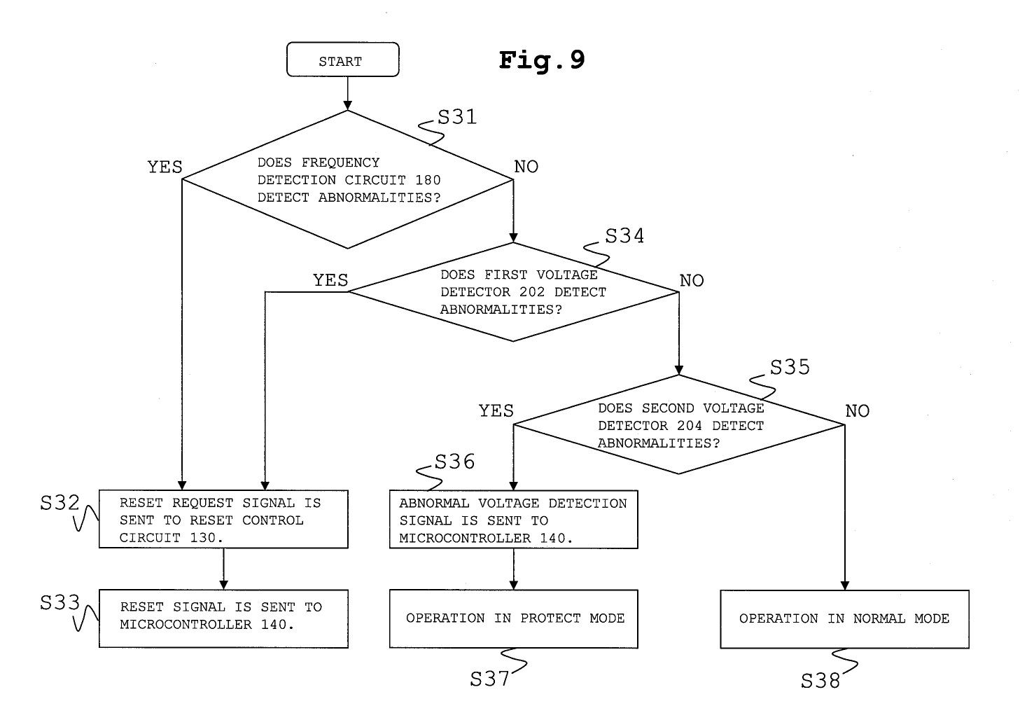

FIG. 9 illustrates an entire control operation by a microcontroller 140 when the frequency detection circuit 180, the first voltage detector 202, and the second voltage detector 204 detect an abnormal value. The abnormal value here means a value outside the range specified by the user's manual, or a value in the range in which CPU 141 cannot read data as expected to the data stored EEPROM 146 of which the performance deteriorates, as mentioned above.

When the frequency detection circuit 180 detects an abnormal frequency value, the operation moves to the initializing operation of the data processing circuit 100B by the similar processing as described above (Steps S31, S32, S33).

When the frequency detection circuit 180 does not detect an abnormal frequency value but the first voltage detector 202 detects an abnormal voltage, the first voltage detector 202 sends a reset request signal 203 to the reset control circuit 130, as in the case where the frequency detection circuit 180 detects an abnormal frequency value (Steps S34, S32). The subsequent processing is the same as that of the case where the frequency detection circuit 180 detects an abnormal frequency value (Step S33).

When the frequency detection circuit 180 and the first voltage detector 202 do not detect an abnormal value but the second voltage detector 204 detects an abnormal voltage, the abnormal voltage detection signal 201 is sent to the microcontroller 140 (Steps S35, S36). Upon receiving the abnormal voltage detection signal 201, the microcontroller 140 shifts to a protect mode (Step S37).

When the frequency detection circuit 180, the first voltage detectors 202, and the second voltage detectors 204 all do not detect an abnormal value, the microcontroller 140 operates in the normal mode without a special limitation in access to the memory of EEPROM 146, etc. (step S38).

According to the constitution of FIGS. 8 and 9, it is possible to directly cope with an act to try to perform unauthorized access by degrading the power supply voltage and inducing malfunction intentionally.

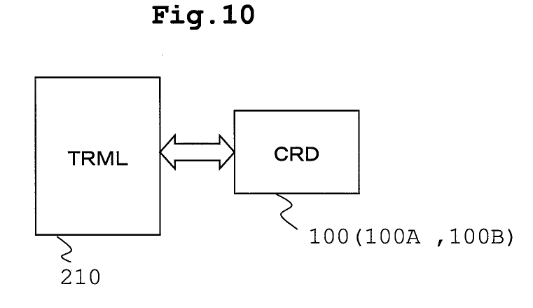

FIG. 10 illustrates a communication mobile terminal device to which the data processing circuit (CRD) 100 (100A, 100B) is applied. The communication mobile terminal device (TRML) 210 is a mobile-phone which employs mobile communications protocols, such as GSM (Global System for Mobile). The data processing circuit 100 (100A, 100B) removably attached to the mobile-phone serves as a subscriber identity module card, and is used for authentication and other security processing of the terminal device. The data processing circuit 100 (100A, 100B) is not restricted to the application to a subscriber identity module card, but can be applied also to an IC card, such as a credit card and an ATM card (the details thereof are not shown). When the data processing circuit 100 (100A, 100B) is applied to a subscriber identity module card or an IC card, the microcontrollers 140 and 140A are called a microcontroller for IC cards.

In the above, the invention accomplished by the present inventors has been specifically explained based on the embodiments. However, it is needless to say that the present invention is not limited to applications described in the embodiments, but can be changed variously in the range which does not deviate from the gist.

For example, the first temperature detector 192 may be added to the data processing circuit of FIG. 1 and FIG. 8, and the microcontroller may be reset when abnormal temperature is detected. Alternatively, the voltage detection circuit 120 may be added to the data processing circuit of FIG. 6, and the microcontroller may be reset when an abnormal voltage is detected. Furthermore, the microcontroller of FIG. 4 may be employed as the data processing circuit of FIG. 6 and FIG. 8. It is not required that the microcontroller for IC cards receives formal authorization by the authentication authority. The circuit module possessed by the microcontroller is not restricted to the above-described explanation, but can be changed suitably. The electrically-rewritable nonvolatile memory may not be restricted to EEPROM, but alternatively, it may be a flash memory etc. The nonvolatile memory represented by EEPROM may be composed of another chip different from the controller 147 represented by CPU. The present invention is applicable to not only an IC card but a memory card or the like having a security function. This kind of memory card is provided with a mass flash memory as a file memory, together with the microcontroller for IC cards, and the microcontroller for IC cards performs necessary security processing.

What is claimed is:

1. A data processing circuit comprising:
a rewritable nonvolatile memory;
a controller operable to perform access control of the nonvolatile memory and external interface control;
a first detector operable to detect whether or not the operation of the data processing circuit deviates from a first operating condition;
a second detector operable to detect whether or not the operation of the data processing circuit deviates from a second operating condition which is severer than the first operating condition; and
a reset circuit operable to instruct the controller to perform reset, in response to a state that the first detector detects deviation from the first operating condition,
wherein when the second detector detects deviation from the second operating condition, the controller makes a backup of an internal state and imposes a restriction on external access to a storage region of the nonvolatile memory.

2. The data processing circuit according to claim 1,
wherein the controller includes an input-output control circuit operable to control input-output with the exterior and
wherein the controller imposes an external input-output restriction on the input-output control circuit when the second detector detects deviation from the second operating condition.

3. The data processing circuit according to claim 1,
wherein the controller includes a counter operable to integrate a period of the operation and to hold an integrated value, and
wherein the integrated value by the counter exceeding a predetermined value is used as one of conditions for imposing the access restriction.

4. The data processing circuit according to claim 2,
wherein the controller includes a counter operable to integrate a period of the operation and to hold an integrated value, and
wherein the integrated value by the counter exceeding a predetermined value is used as one of conditions for imposing the external input-output restriction.

5. The data processing circuit according to claim 1,
wherein the nonvolatile memory has a monitoring area which stores specific data in a part of a storage area in write-in units and is enabled to be electrically written in the write-in units, and
wherein when the controller detects that data read from the monitoring area in accessing the nonvolatile memory is altered to data other than the specific data, the detection by the controller is used as one of conditions for imposing the access restriction.

6. The data processing circuit according to claim 2,
wherein the nonvolatile memory has a monitoring area which stores specific data in a part of a storage area in write-in units and is enabled to be electrically written in the write-in units, and
wherein when the controller detects that data read from the monitoring area in accessing the nonvolatile memory is altered to data other than the specific data, the detection by the controller is used as one of conditions for imposing the external input-output restriction.

7. The data processing circuit according to claim 1,
wherein the first operating condition is one of operation guarantee conditions in operation specifications of the data processing circuit.

8. The data processing circuit according to claim 1,
wherein the first detector and the second detector input a clock signal supplied from an external clock contact, and
wherein the first operating condition is that a frequency of the clock signal is within the range of a first frequency band and the second operating condition is that the frequency of the clock signal is within the range of a second frequency band which is set in the first frequency band.

9. The data processing circuit according to claim 1,
wherein the first detector and the second detector input a power supply voltage supplied from an external power contact, and
wherein the first operating condition is that the power supply voltage is within a first voltage range and the second operating condition is that the power supply voltage is within a second voltage range which is set in the first voltage range.

10. The data processing circuit according to claim 1,
wherein the first detector and the second detector detect temperature of the data processing circuit, and
wherein the first operating condition is that the detected temperature is within a first temperature range and the second operating condition is that the detected temperature is within a second temperature range which is set in the first temperature range.

11. The data processing circuit according to claim 1,
wherein the data processing circuit comprises the controller and the nonvolatile memory as a microcontroller for IC cards and further comprises an external contact in conformity with the ISO 7816-2 standard.

12. The data processing circuit according to claim 11,
wherein the data processing circuit serves as a subscriber identity module card.

13. A communication terminal device comprising:
a data processing circuit as described in claim 12 as a subscriber identity module card.
